(19) United States
(12) Patent Application Publication
(10) Pub. No.: US 2012/0325551 A1
(43) Pub. Date: Dec. 27, 2012

(54) FLAT COAXIAL CABLE AND FABRICATING METHOD THEREOF

(75) Inventors: Chien-Chun Wu, Taipei City (TW); Shih-Wei Li, Taipei City (TW)

(73) Assignee: COMPAL ELECTRONICS, INC., Taipei City (TW)

(21) Appl. No.: 13/241,211

(22) Filed: Sep. 23, 2011

(30) Foreign Application Priority Data
Jun. 24, 2011 (TW) 100122280

(51) Int. Cl. H01B 7/08; B32B 37/14; H02G 15/02; B32B 37/16

(52) U.S. Cl. 174/74 R; 174/107; 156/306.6; 156/150; 156/278

(57) ABSTRACT

A flat coaxial cable includes an insulating base layer, a conductor line layer, an insulating cover layer, an electromagnetic shield layer and an outer insulating layer. The conductive layer is disposed on the insulating base layer. The insulating cover layer and the insulating base layer encompass the conductor line layer, wherein the insulating cover layer and the insulating base layer form an inner insulating layer. The electromagnetic shield layer encompasses the inner insulating layer. The outer insulating layer encompasses the electromagnetic shield layer.

### CROSS-REFERENCE TO RELATED APPLICATION

This application claims the priority benefit of Taiwan application serial no. 100122280, filed Jun. 24, 2011. The entirety of the above-mentioned patent application is hereby incorporated by reference herein and made a part of this specification.

### BACKGROUND OF THE INVENTION

1. Field of the Invention

The present invention relates to a coaxial cable, and more particularly, to a flat coaxial cable and a method for fabricating the flat coaxial cable.

2. Description of Related Art

Coaxial cables are often used to transmit signals to ensure the stability of the signal transmission. Conventional flat coaxial cables include an internal conductor which includes a single line or twisted lines made of a metal material (e.g. copper, copper-plated aluminium, or copper-plated tin), an inner insulating layer (e.g. Teflon layer) encompassing the internal conductor, an electromagnetic shield layer (e.g. copper wire mesh) encompassing the inner insulating layer, and an outer insulator (e.g. flame resistant polymer layer) encompassing the electromagnetic shield layer. Based on the above architecture, the coaxial cable usually has a cylindrical structure.

An outer diameter of the coaxial cable may vary according to need. However, when the coaxial cable is used in low profile electronic products, the outer diameter of the coaxial cable has a minimum limit of size in order to meet some electrical requirements. Therefore, the current architecture of the coaxial cable is disadvantageous in achieving a lower profile of the electronic products.

### SUMMARY OF THE INVENTION

Accordingly, the present invention is directed to a flat coaxial cable which has a lower profile.

The present invention is also directed to a method for fabricating a flat coaxial cable which can fabricate a flat coaxial cable with a lower profile.

The present invention discloses a flat coaxial cable which includes an insulating base layer, a conductor line layer, an insulating cover layer, an electromagnetic shield layer and an outer insulating layer. The conductive layer is disposed on the insulating base layer. The insulating cover layer and the insulating base layer encompass the conductor line layer, wherein the insulating cover layer and the insulating base layer form an inner insulating layer. The electromagnetic shield layer encompasses the inner insulating layer. The outer insulating layer encompasses the electromagnetic shield layer.

The present invention further discloses a method for fabricating a flat coaxial cable. In this method, a conductor line layer is formed on an insulating base layer. An insulating cover layer and the insulating base layer are used to encompass the conducting line layer, wherein the insulating base layer and the insulating cover layer form an inner insulating layer. An electromagnetic shield layer encompasses the inner insulating layer, such that the electromagnetic shield layer is located between the inner insulating layer and the outer insulating layer.

In view of the foregoing, the flat coaxial cable of the present invention utilizes a laminar conductor line layer to replace the internal conductor (e.g. single line or twisted lines) of the conventional coaxial cable to reduce the thickness of the coaxial cable. Therefore, this facilitates achieving a lower profile of electronic products. In addition, the method for fabricating the flat coaxial cable of the present invention can be used to fabricate a flat coaxial cable.

### BRIEF DESCRIPTION OF THE DRAWINGS

FIG. 1 is a top view of a flat coaxial cable according to one embodiment of the present invention.

FIG. 2 is an enlarged cross-sectional view of the flat coaxial cable of FIG. 1 taken along line A-A thereof.

FIG. 3 is a cross-sectional view of a flat coaxial cable according to another embodiment of the present invention.

FIG. 4 is a perspective view of a flat coaxial cable according to another embodiment of the present invention.

FIG. 5A to FIG. 5C illustrates a method for fabricating a flat coaxial cable according to another embodiment of the present invention.

FIG. 6A to FIG. 6C illustrates a method for fabricating a flat coaxial cable according to another embodiment of the present invention.

FIG. 7A to FIG. 7C illustrates a method for fabricating a flat coaxial cable according to another embodiment of the present invention.

FIG. 8A to FIG. 8C illustrates a method for fabricating a flat coaxial cable according to another embodiment of the present invention.

### DESCRIPTION OF THE EMBODIMENTS

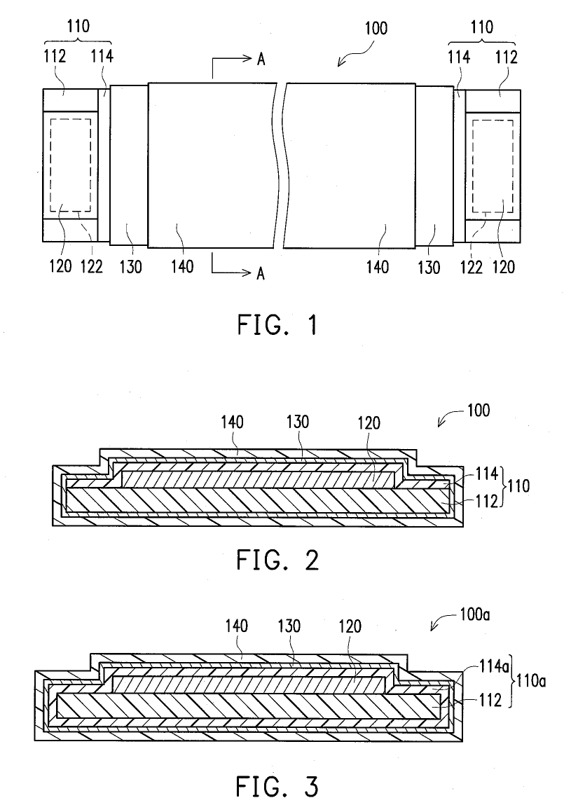

FIG. 1 is a top view of a flat coaxial cable according to one embodiment of the present invention. FIG. 2 is an enlarged cross-sectional view of the flat coaxial cable of FIG. 1 taken along line A-A thereof. Referring to FIG. 1 and FIG. 2, the flat coaxial cable 100 includes an insulating base layer 112. In the present embodiment, the material of the insulating base layer 112 may be a soft polymer, such as PI, PET, PC, or like, which is insulative, has a good dielectric strength and is chemical resistant.

The flat coaxial cable 100 of this embodiment further includes a conductor line layer 120 disposed on the insulating base layer 112. In the present embodiment, the material of the conductor line layer 120 may be gold, silver or copper. A width of the conductor line layer 120 may range between 0.5 cm and 2 cm, and a thickness of the conductor line layer 120 may range between 50 μm (micrometer) and 200 μm. Different from the conventional cylindrical coaxial cable in which a cross-section of an inner conductor (e.g. single line or twisted lines) has a substantially uniform outer diameter, the ratio of the width to thickness of the conductor line layer 120 is at least greater than 2.

The flat coaxial cable 100 of the present embodiment further includes an insulating cover layer 114 disposed on the insulating layer 112. The insulating cover layer 114 and the insulating base layer 112 cooperatively encompass the conductor line layer 120. As shown in FIG. 1, the conductor line layer 120 may include two end electrodes 122 that are not covered by the insulating cover layer 114. The insulating base layer 112 and the insulating cover layer 114 form an inner insulating layer 110. In the present embodiment, the material of the insulating cover layer 114 may be a soft polymer, such as PI, PET, PC, or like, which is insulative and has a good dielectric strength.

The flat coaxial cable 100 of the present embodiment further includes an electromagnetic shield layer 130 encompassing the insulating base layer 112 and the insulating cover layer 114. In the present embodiment, the material of the electromagnetic shield layer 130 may be aluminium.

The flat coaxial cable 100 of the present embodiment further includes an outer insulating layer 140 encompassing the electromagnetic shield layer 130. In the present embodiment, the material of the outer insulating layer 140 may be a soft polymer, such as PI, PET, PC, or like, which is insulative and has a good dielectric strength and flame resistance.

FIG. 3 is a cross-sectional view of a flat coaxial cable of another embodiment of the present invention. Referring to FIG. 3, different from the flat coaxial cable 100 of FIG. 2 in which the insulating cover layer 114 is only disposed on a side of the insulating base layer 112 where the insulating line layer 120 is disposed, the insulating cover layer 114a of the flat coaxial cable 100a of the present embodiment further encompasses the insulating base layer 112, such that the electromagnetic shield layer 130 is located between the insulating cover layer 114 and the outer insulating layer 140. In the present embodiment, the material of the insulating cover layer 114a may also be a soft polymer, such as PI, PET, PC, or like, which is insulative and has a good dielectric strength.

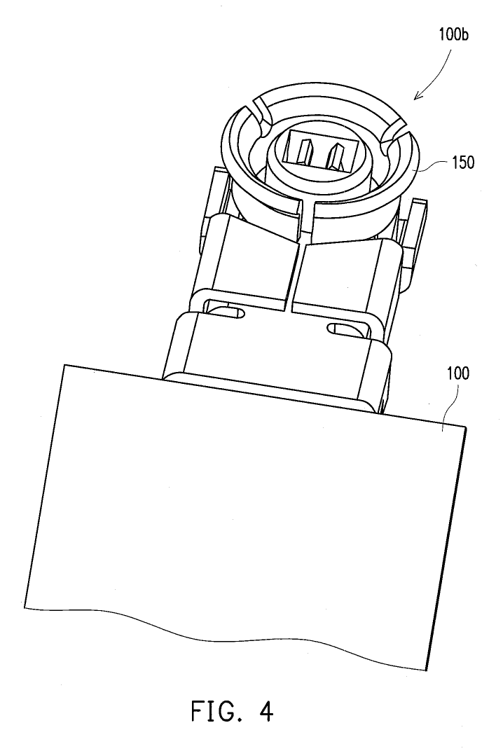

FIG. 4 is a perspective view of a flat coaxial cable according to another embodiment of the present invention. Referring to FIG. 4, in addition to all the elements of the flat coaxial cable 100 of FIG. 1, the flat coaxial cable 100b of the present embodiment further includes an electrical connector 150 connected to one end electrode (similar to the end electrode of FIG. 1) of the conductor line layer.

Having described structure embodiments above with reference to FIG. 1 to FIG. 4, method embodiments will be described below with reference to the figures.

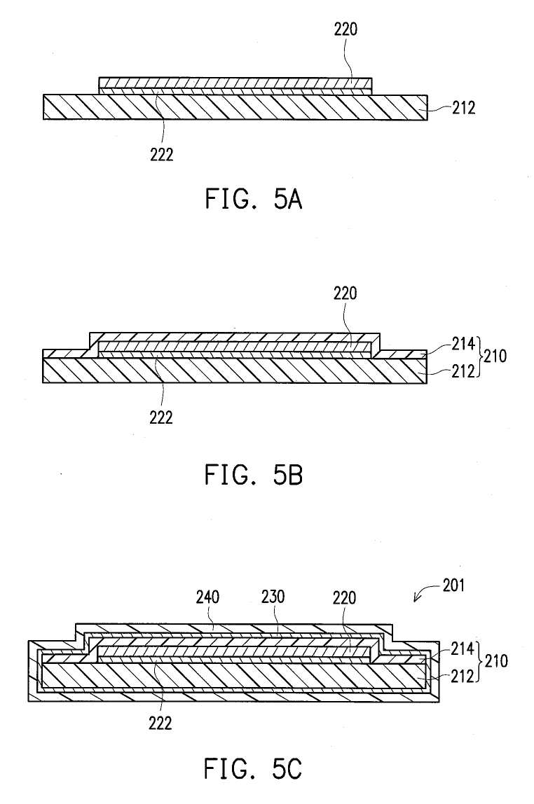

FIG. 5A to FIG. 5C illustrates a method for fabricating a flat coaxial cable according to one embodiment of the present invention. Referring to FIG. 5A, a conductor line layer 220 is formed on an insulating base layer 212. In the present embodiment, the insulating base layer 212 may be supplied and delivered in the form of roll material or sheet material. In the present embodiment, the material of the insulating base layer 212 may be a soft polymer, such as PI, PET, PC, or like, which is insulative, has a good dielectric strength and is chemical resistant.

In addition, in the present embodiment, the step of forming the conductor line layer 220 may include forming a bridge layer 222 on the insulating base layer 212 by chemical plating, and subsequently forming an electroplating layer as the conductor line layer 220 on the bridge layer 222 by electroplating. The bridge layer 222 is disposed between the insulating base layer 212 and the conductor line layer 220, and the conductor line layer 220 is disposed on the insulating base layer 212 by means of the bridge layer 222. The material of the bridge layer 222 may be nickel, and the material of the conductor line layer 220 may be gold, silver or copper.

Referring to FIG. 5B, an insulating cover layer 214 and the insulating base layer 212 are used to encompass the conductor line layer 220. The insulating base layer 212 and the insulating cover layer 214 form an inner insulating layer 210. In the present embodiment, the insulating cover layer 214 may be formed on the insulating base layer 212 and the conductor line layer 220 by coating a liquid insulating material. The material of the insulating cover layer 214 may be a soft polymer, such as PI or like, which is insulative and has a good dielectric strength.

Referring to FIG. 5C, an electromagnetic shield layer 230 and an outer insulating layer 240 are used to encompass the inner insulating layer 210, such that the electromagnetic shield layer 230 is located between the inner insulating layer 210 and the outer insulating layer 240, thereby achieving the flat coaxial cable 201. In the present embodiment, the electromagnetic shield layer 230 may be formed on the outer insulating layer 240, and the outer insulating layer 240 formed with the electromagnetic shield layer 230 is subsequently attached to the inner insulating layer 210. The electromagnetic shield layer 230 may be formed on the outer insulating layer 240 by aluminium evaporation or attaching an aluminium foil. The material of the outer insulating layer 240 may be a soft polymer, such as PI, PET, PC, or like, which is insulative and has a good dielectric strength and flame resistance.

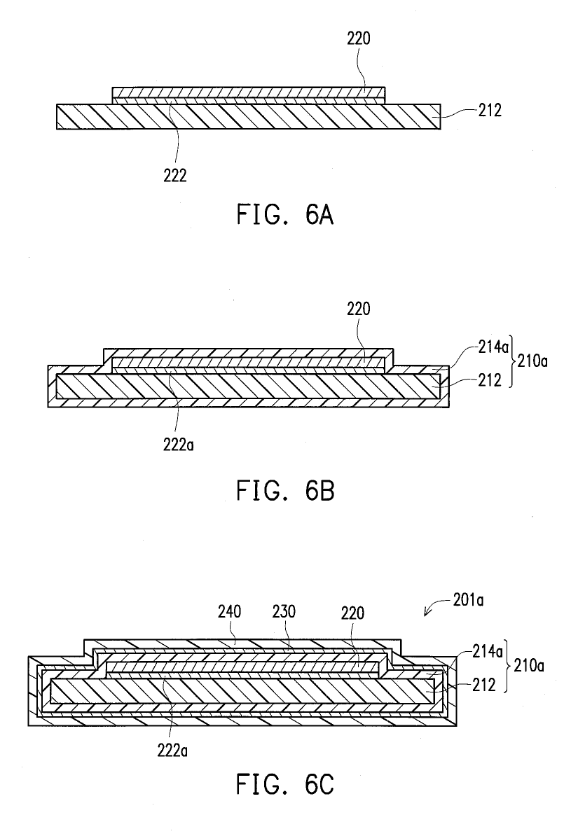

FIG. 6A to FIG. 6C illustrate a method for fabricating a flat coaxial cable according to another embodiment of the present invention. Referring to FIG. 6A, a conductor line layer 220 is formed on an insulating base layer 212. In the present embodiment, the insulating base layer 212 may be supplied and delivered in the form of roll material or sheet material. The material of the insulating base layer 212 may be a soft polymer, such as PI, PET, PC, or like, which is insulative, has a good dielectric strength and is chemical resistant.

In addition, in the present embodiment, the step of forming the conductor line layer 220 may include forming a bridge layer 222 on the insulating base layer 212 by chemical plating, and subsequently forming an electroplating layer as the conductor line layer 220 on the bridge layer 222 by electroplating. The bridge layer 222 is disposed between the insulating base layer 212 and the conductor line layer 220, and the conductor line layer 220 is disposed on the insulating base layer 212 by means of the bridge layer 222. The material of the bridge layer 222 may be nickel, and the material of the conductor line layer 220 may be gold, silver or copper.

Referring to FIG. 6B, an insulating cover layer 214a and the insulating base layer 212 are used to encompass the conductor line layer 220. The insulating base layer 212 and insulating cover layer 214a form an inner insulating layer 210a. In the present embodiment, the insulating cover layer 214a may be formed by attaching an insulating film to encompass the insulating base layer 212 and the conductor line layer 220. The material of the insulating cover layer 214a may be a soft polymer, such as PI, PET, PC, or like, which is insulative and has a good dielectric strength.

Referring to FIG. 6C, an electromagnetic shield layer 230 and an outer insulating layer 240 are used to encompass the inner insulating layer 210a, such that the electromagnetic shield layer 230 is located between the inner insulating layer 210a and the outer insulating layer 240, thereby achieving the flat coaxial cable 201. In the present embodiment, the electromagnetic shield layer 230 may be formed on the outer insulating layer 240, and the outer insulating layer 240 formed with the electromagnetic shield layer 230 is subsequently attached to the inner insulating layer 210a. The electromagnetic shield layer 230 may be formed on the outer insulating layer 240 by aluminium evaporation or attaching an aluminium foil. The material of the outer insulating layer 240 may be a soft polymer, such as PI, PET, PC, or like, which is insulative and has a good dielectric strength and flame resistance.

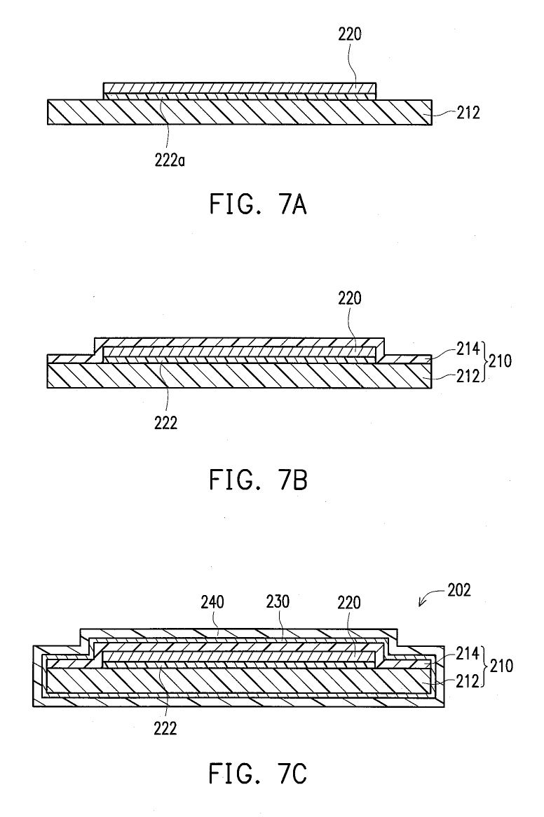

FIG. 7A to FIG. 7C illustrate a method for fabricating a flat coaxial cable according to another embodiment of the present invention. Referring to FIG. 7A, a conductor line layer 220 is formed on an insulating base layer 212. In the present embodiment, the insulating base layer 212 may be supplied and delivered in the form of roll material or sheet material. The material of the insulating base layer 212 may be a soft polymer, such as PI, PET, PC, or like, which is insulative, has a good dielectric strength and is chemical resistant.

In addition, in the present embodiment, the step of forming the conductor line layer 220 may include attaching a conductor foil sheet (e.g. gold foil, silver foil, or copper foil) to the insulating base layer 212 as the conductor line layer 220 by means of an adhesive layer 222a. The adhesive layer 222a is disposed between the insulating base layer 212 and the conductor line layer 220, and the conductor line layer 220 is disposed on the insulating base layer 212 by means of the adhesive layer 222a.

Referring to FIG. 7B, an insulating cover layer 214 and the insulating base layer 212 are used to encompass the conductor line layer 220. The insulating base layer 212 and the insulating cover layer 214 form an inner insulating layer 210. In the present embodiment, the insulating cover layer 214 may be formed on the insulating base layer 212 and the conductor line layer 220 by coating a liquid insulating material. The material of the insulating cover layer 214 may be a soft polymer, such as PI or like, which is insulative and has a good dielectric strength.

Referring to FIG. 7C, an electromagnetic shield layer 230 and an outer insulating layer 240 are used to encompass the inner insulating layer 210, such that the electromagnetic shield layer 230 is located between the inner insulating layer 210 and the outer insulating layer 240, thereby achieving the flat coaxial cable 201. In the present embodiment, the electromagnetic shield layer 230 may be formed on the outer insulating layer 240, and the outer insulating layer 240 formed with the electromagnetic shield layer 230 is subsequently attached to the inner insulating layer 210. The electromagnetic shield layer 230 may be formed on the outer insulating layer 240 by aluminium evaporation or attaching an aluminium foil. The material of the outer insulating layer 240 may be a soft polymer, such as PI, PET, PC, or like, which is insulative and has a good dielectric strength and flame resistance.

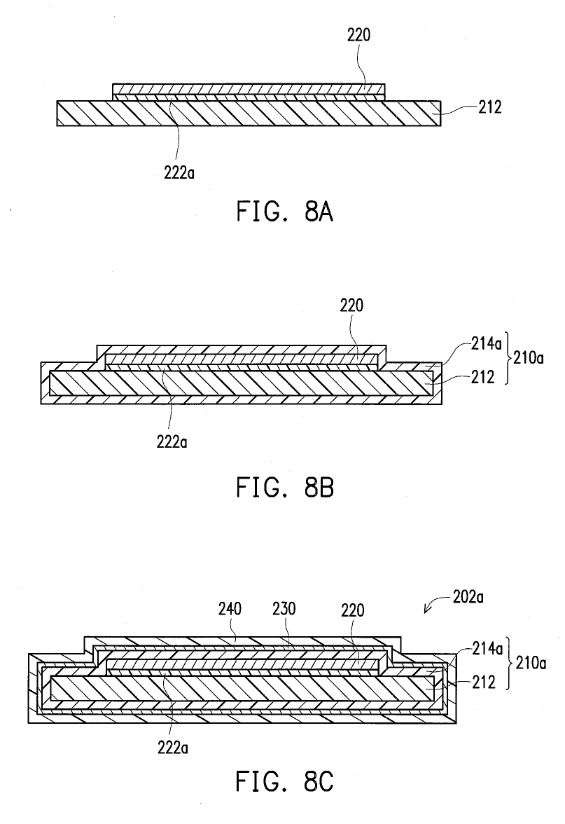

FIG. 8A to FIG. 8C illustrate a method for fabricating a flat coaxial cable according to another embodiment of the present invention. Referring to FIG. 8A, a conductor line layer 220 is formed on an insulating base layer 212. In the present embodiment, the insulating base layer 212 may be supplied and delivered in the form of roll material or sheet material. The material of the insulating base layer 212 may be a soft polymer, such as PI, PET, PC, or like, which is insulative, has a good dielectric strength and is chemical resistant.

In addition, in the present embodiment, the step of forming the conductor line layer 220 may include attaching a conductor foil sheet (e.g. gold foil, silver foil, or copper foil) to the insulating base layer 212 as the conductor line layer 220 by means of an adhesive layer 222a. The adhesive layer 222a is disposed between the insulating base layer 212 and the conductor line layer 220, and the conductor line layer 220 is disposed on the insulating base layer 212 by means of the adhesive layer 222a.

Referring to FIG. 8B, an insulating cover layer 214a and the insulating base layer 212 are used to encompass the conductor line layer 220. The insulating base layer 212 and insulating cover layer 214a form an inner insulating layer 210a. In the present embodiment, the insulating cover layer 214a may be formed by attaching an insulating film to encompass the insulating base layer 212 and the conductor line layer 220. The material of the insulating cover layer 214a may be a soft polymer, such as PI, PET, PC, or like, which is insulative and has a good dielectric strength.

Referring to FIG. 8C, an electromagnetic shield layer 230 and an outer insulating layer 240 are used to encompass the inner insulating layer 210a, such that the electromagnetic shield layer 230 is located between the inner insulating layer 210a and the outer insulating layer 240, thereby achieving the flat coaxial cable 201. In the present embodiment, the electromagnetic shield layer 230 may be formed on the outer insulating layer 240, and the outer insulating layer 240 formed with the electromagnetic shield layer 230 is subsequently attached to the inner insulating layer 210a. The electromagnetic shield layer 230 may be formed on the outer insulating layer 240 by aluminium evaporation or attaching an aluminium foil. The material of the outer insulating layer 240 may be a soft polymer, such as PI, PET, PC, or like, which is insulative and has a good dielectric strength and flame resistance.

In summary, the flat coaxial cable of the present invention utilizes a laminar conductor line layer to replace the internal conductor (e.g. single line or twisted lines) of the conventional coaxial cable to reduce the thickness of the coaxial cable. Therefore, this facilitates achieving a lower profile of electronic products. In addition, the method for fabricating the flat coaxial cable of the present invention can be used to fabricate a flat coaxial cable.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A flat coaxial cable comprising:
an insulating base layer;
a conductor line layer disposed on the insulating base layer;
an insulating cover layer cooperating with the insulating base layer to encompass the conductor line layer, wherein the insulating base layer and the insulating cover layer form an inner insulating layer;
an electromagnetic shield layer encompassing the inner insulating layer; and
an outer insulating layer encompassing the electromagnetic shield layer.

2. The flat coaxial layer according to claim 1, further comprising:
a bridge layer disposed between the insulating base layer and the conductor line layer, wherein the conductor line layer is disposed on the insulating base layer by means of the bridge layer.

3. The flat coaxial layer according to claim 1, further comprising:
an adhesive layer disposed between the insulating base layer and the conductor line layer, wherein the conductor line layer is disposed on the insulating base layer by means of the adhesive layer.

4. The flat coaxial layer according to claim 1, wherein the insulating cover layer further encompasses the insulating base layer, and the electromagnetic shield layer is disposed between the insulating cover layer and the outer insulating layer.

5. The flat coaxial layer according to claim 1, wherein the material of the insulating base layer is a soft polymer.

6. The flat coaxial layer according to claim 1, wherein the material of the conductor line layer is gold, silver or copper.

7. The flat coaxial layer according to claim 1, wherein the material of the insulating cover layer is soft polymer.

8. The flat coaxial layer according to claim 1, wherein the material of the electromagnetic shield layer is aluminium.

9. The flat coaxial layer according to claim 1, wherein the material of the outer insulating material is soft polymer.

10. The flat coaxial layer according to claim 1, wherein a width of the conductor line layer ranges between 0.5 cm and 2 cm.

11. The flat coaxial layer according to claim 1, wherein a thickness of the conductor line layer ranges between 50 μm and 200 μm.

12. The flat coaxial layer according to claim 1, wherein a ratio of a width to a thickness of the conductor line layer is greater than 2.

13. The flat coaxial layer according to claim 1, further comprising:
an electrical connector connected to an end electrode of the conductor line layer.

14. A method for fabricating a flat coaxial cable, comprising:
forming a conductor line layer on an insulating base layer;
encompassing the conducting line layer using an insulating cover layer and the insulating base layer, wherein the insulating base layer and the insulating cover layer form an inner insulating layer; and
encompassing the inner insulating layer using an electromagnetic shield layer, wherein the electromagnetic shield layer is located between the inner insulating layer and the outer insulating layer.

15. The method for fabricating a flat coaxial cable according to claim 14, wherein the insulating base layer is supplied and delivered in the form of a roll material or sheet material.

16. The method for fabricating a flat coaxial cable according to claim 14, wherein the step of forming the conductor line layer comprises:
forming a bridge layer on the insulating base layer by chemical plating; and
forming a plating layer on the bridge layer as the conductor line layer by electroplating.

17. The method for fabricating a flat coaxial cable according to claim 14, wherein the step of forming the conductor line layer comprises attaching a conductor foil sheet to the insulating base layer as the conductor line layer by means of an adhesive layer.

18. The method for fabricating a flat coaxial cable according to claim 14, wherein the step of encompassing the conductor line layer comprises forming the insulating cover layer by coating a liquid insulating material on the insulating base layer and the conductor line layer.

19. The method for fabricating a flat coaxial cable according to claim 14, wherein the step of encompassing the conductor line layer comprises forming the insulating cover layer by attaching an insulating film to encompass the insulating base layer and the conductor line layer.

20. The method for fabricating a flat coaxial cable according to claim 14, wherein the step of encompassing the inner insulating layer comprises:
forming the electromagnetic shield layer on the outer insulating layer; and
attaching the outer insulating layer formed with the electromagnetic shield layer to the inner insulating layer.

21. The method for fabricating a flat coaxial cable according to claim 20, wherein the electromagnetic shield layer is formed on the outer insulating layer by aluminium evaporation.

22. The method for fabricating a flat coaxial cable according to claim 20, wherein the electromagnetic shield layer is formed on the outer insulating layer by attaching an aluminium foil.
